(19) United States
(12) Patent Application Publication
(10) Pub. No.: US 2022/0272972 A1
(43) Pub. Date: Sep. 1, 2022

(54) WEED CONTROL PRODUCT

(71) Applicant: Pouch Pac Innovations, LLC, Sarasota, FL (US)

(72) Inventors: R. Charles Murray, Sarasota, FL (US); John Harlin, Sarasota, FL (US)

(21) Appl. No.: 17/636,670

(22) PCT Filed: Aug. 21, 2020
(86) PCT No.: PCT/US2020/047395

§ 371 Date: Feb. 18, 2022

Related U.S. Application Data
(60) Provisional application No. 62/889,727, filed on Aug. 21, 2019.

(51) Int. Cl. A01N 37/02; A01P 13/00; A01N 59/06; A01N 59/02; A01N 59/08; A01N 65/22; A01N 61/00

(52) U.S. Cl. CPC A01N 37/02; A01P 13/00; A01N 59/06; A01N 59/02; A01N 59/08; A01N 65/22; A01N 61/00

(57) ABSTRACT

A weed control product includes acetic acid, citric acid, magnesium sulfate, sodium sulfate, soap, sodium chloride and peppermint oil.

### CROSS REFERENCE TO RELATED APPLICATION

This application claims priority to U.S. application Ser. No. 16/889,727 filed on Aug. 21, 2019, the entire disclosure of which is hereby incorporated by reference.

### FIELD OF THE INVENTION

The instant application is directed to a formulation for a non-toxic weed control product.

### BACKGROUND OF THE INVENTION

Various weed killers or herbicides are known in the art. Some of these products have been accused of being detrimental to humans upon a certain level of exposure.

Accordingly, a natural non-toxic ingredient based product that controls weeds would be desirable.

### SUMMARY OF THE INVENTION

In one aspect, there is disclosed a weed control product including acetic acid, citric acid, magnesium sulfate, sodium sulfate, soap, sodium chloride and peppermint oil.

In another aspect, there is disclosed a method of killing weeds comprising: applying a weed control product to a weed as a spray wherein the control product comprises: acetic acid, citric acid, magnesium sulfate, sodium sulfate, soap, sodium chloride and peppermint oil.

### BRIEF DESCRIPTION OF THE DRAWINGS

FIG. 1 is a photographic image of an untreated weed;

FIG. 2 is a photographic image of a treated weed after 40 minutes.

### DETAILED DESCRIPTION OF THE EMBODIMENTS

In one aspect, there is disclosed herein a formulation that may be utilized as a weed control product. The formulation may include natural and ecologically sound compositions that will control weeds.

### EXAMPLE 1

In one aspect, the composition may include the following formula:

TABLE 1

| INGREDIENTS | PERCENTAGE | DENSITY |
|---|---|---|
| Acetic Acid 8 | 60.5 | 1.05 |
| Citric Acid | 20 | 1.66 |
| Magnesium Sulfate | 10 | 2.66 |
| Sodium Sulfate | 0.5 | 2.66 |
| Soap | 2 | 1.01 |
| Sodium chloride | 5 | 2.16 |
| Peppermint oil | 2 | .898 |
| Totals | 100 | |

The composition may include acetic acid (8% aqueous by volume), citric acid (anhydrous), magnesium sulfate (present as Epsom salt), sodium sulfate, soap, sodium chloride and peppermint oil.

The weight percentages of the composition are given above in table 1. The amounts of the components may vary as described below. The acetic acid may vary in an amount of from 6 to 6.5% by weight. The Citric Acid may vary in an amount of from 2 to 3% by weight. The magnesium sulfate may vary in an amount of from 1 to 2% by weight. The sodium sulfate may vary in an amount of from 1 to 2% by weight. The soap may vary in an amount of from 1 to 2% by weight. The sodium chloride may vary in an amount of from 2 to 3% by weight. The peppermint oil may vary in an amount of from 2 to 3% by weight. The weight percentages are based on a total weight of the composition.

The active ingredients include sodium chloride and peppermint oil. The inert ingredients include acetic acid or vinegar, citric acid, magnesium sulfate, soap and sodium sulfate.

The composition was made according to the following procedure. Acetic acid (30% by volume was diluted with distilled water to a concentration of 8% by volume. The diluted acetic acid is mixed with the sodium sulfate to form a solution. The citric acid, sodium chloride, magnesium sulfate, soap and peppermint oil are dissolved in the solution to form the final composition.

Testing

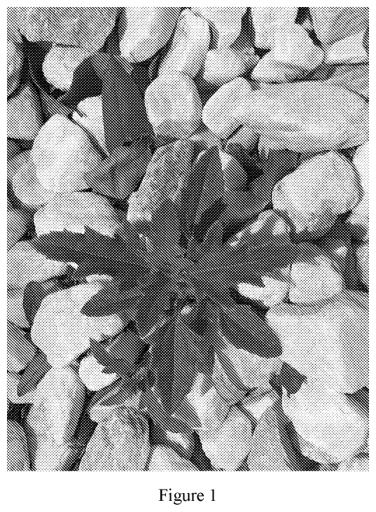

The above composition of example 1 was placed in a sprayer and applied to weeds. The untreated weed is shown in FIG. 1.

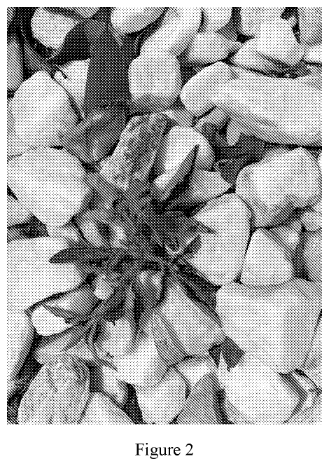

The weeds were visually monitored for a specified time period. There was appreciable withereing of the weeds at 40 minutes as shown in FIG. 2. The weeds continued to wither at time 24 hours. The weeds showed no regrowth at 1 week.

While not wishing to be bound by theory, it is believed that composition pentrates the cell walls of the weed and carries the acid ingredients into the weed killing the weed. The above composition is an ecologically safe weed control product that is not harmful to humans and the environment. The composition may be classified as a minimum risk pesticide.

1. A weed control product comprising:
acetic acid, citric acid, magnesium sulfate, sodium sulfate, soap, sodium chloride and peppermint oil.

2. The weed control product of claim 1 wherein the acetic acid may vary in an amount of from 6 to 6.5% by weight, the Citric Acid may vary in an amount of from 2 to 3% by weight, the magnesium sulfate may vary in an amount of from 1 to 2% by weight, the sodium sulfate may vary in an amount of from 1 to 2% by weight, the soap may vary in an amount of from 1 to 2% by weight, the sodium chloride may vary in an amount of from 2 to 3% by weight, the peppermint oil may vary in an amount of from 2 to 3% by weight wherein the the weight percentages are based on a total weight of the product.

3. The weed control product of claim 1 wherein acetic acid is 8% aqueous by volume.

4. The weed control product of claim 1 wherein the citric acid is anhydrous.

5. The weed control product of claim 1 wherein the magnesium sulfate is present as Epsom salt.

6. A method of killing weeds comprising:
applying a weed control product to a weed as a spray wherein the control product comprises: acetic acid, citric acid, magnesium sulfate, sodium sulfate, soap, sodium chloride and peppermint oil.

7. The method of claim 5 wherein after 40 minutes there is withereing of the weed.

8. The method of claim 5 wherein after one week there is no regrowth of the weed.
